(19) United States
(12) Patent Application Publication
(10) Pub. No.: US 2015/0258699 A1
(43) Pub. Date: Sep. 17, 2015

(54) CUTTING DEVICE AND CUTTING METHODS

(71) Applicant: PAZZLES, INC., KUNA, ID (US)

(72) Inventor: JEREMY SIMON VANDER WOUDE, BOISE, ID (US)

(21) Appl. No.: 14/632,837

(22) Filed: Feb. 26, 2015

Related U.S. Application Data
(60) Provisional application No. 61/945,663, filed on Feb. 27, 2014.
(60) Provisional application No. 61/944,651, filed on Feb. 26, 2014.

(51) Int. Cl. B26D 5/20; B26F 1/38; B26D 7/01

(52) U.S. Cl. CPC B26D 5/20; B26D 7/015; B26F 1/3813

(57) ABSTRACT

A material modifying device for use in modifying a sheet material. The material modifying device comprising: an instrument for modifying the sheet material, a carriage, a sheet material holder for holding the sheet material on said surface; a controller for receiving modification instructions for how the instrument is to modify the sheet material, and at least one sensor configured for sensing the position of the sheet material, the sensor generating at least one position signal, the position signal received by the controller, wherein considering the position signal, the controller executes the modification instructions and moves the carriage relative to the sheet material holder and the sheet material holder relative to the carriage so that the instrument modifies the sheet material according to the modification instructions.

### TECHNICAL FIELD

This application is a non-provisional of, and claims the benefit of, U.S. Provisional Application No. 61/944,651 (filed 26 Feb. 2014), the disclosure of which is incorporated herein by reference.

This application is a non-provisional of, and claims the benefit of, U.S. Provisional Application No. 61/945,663 (filed 27 Feb. 2014), the disclosure of which is incorporated herein by reference.

### TECHNICAL FIELD

The disclosure generally relates to the field of sheet material modifying devices. Particular embodiments relate to desktop devices used by consumers to cut or otherwise modify sheet material (e.g., sheets of paper).

### BRIEF DESCRIPTION OF THE DRAWINGS

FIG. 1 is a front side elevation view of a first exemplary material modifying device.

FIG. 2 is a front side perspective view of the exemplary material modifying device of FIG. 1.

FIG. 3 is a partial, plan view of an exemplary sheet material holder and sheet material used with an exemplary material modifying device.

FIG. 4 is a plan view of an exemplary calibration sheet used with an exemplary material modifying device.

FIG. 5 is a plan view of an exemplary sheet material used with an exemplary material modifying device.

### DETAILED DESCRIPTION

The following description and the referenced drawings provide illustrative examples of that which the inventor regards as his invention. As such, the embodiments discussed herein are merely exemplary in nature and are not intended to limit the scope of the invention, or its protection, in any manner. Rather, the description and illustration of these embodiments serve to enable a person of ordinary skill in the relevant art to practice the invention.

The use of “e.g.,” “etc,” “for instance,” “in example,” “for example,” and “or” and grammatically related terms indicates non-exclusive alternatives without limitation, unless otherwise noted. The use of “including” and grammatically related terms means “including, but not limited to,” unless otherwise noted. The use of the articles “a,” “an” and “the” are meant to be interpreted as referring to the singular as well as the plural, unless the context clearly dictates otherwise. Thus, for example, reference to “a registration mark” includes two or more such registration marks, and the like. The use of “optionally,” “alternatively,” and grammatically related terms means that the subsequently described element, event or circumstance may or may not be present/occur, and that the description includes instances where said element, event or circumstance occurs and instances where it does not. The use of “preferred,” “preferably,” and grammatically related terms means that a specified element or technique is more acceptable than another, but not that such specified element or technique is a necessity, unless the context clearly dictates otherwise. The use of “exemplary” means “an example of” and is not intended to convey a meaning of an ideal or preferred embodiment. Words of approximation (e.g., “substantially,” “generally”), as used in context of the specification and figures, are intended to take on their ordinary and customary meanings which denote approximation, unless the context clearly dictates otherwise.

The use of “material modifying device” means a device (e.g., die-cut machine, stand-alone printer, computer printer, cutting machine, plotter, plotting device) used for modifying a material or surface of material (e.g., printing vector graphics, cutting, embossing, piercing, engraving, distressing), unless the context clearly dictates otherwise. One example of a material modifying device 10 is the INSPIRATION die-cut machine manufactured by Pazzles, Inc.

The use of “material holder” means a surface, such as a mat, configured for supporting material to be modified by an instrument, unless the context clearly dictates otherwise.

The use of “sheet material” means a material that is thin in comparison to its length and breadth, including but not limited to sheets or films of paper, Mylar, vinyl, fabric, plastics, metals, and composites, unless the context clearly dictates otherwise.

The use of “angle of the sheet material” and the like means the slope of the sheet material on the sheet material holder relative to the absolute X and Y axes of the material modifying device, unless the context clearly dictates otherwise.

The use of “compression,” as in “X-axis compression” and “Y-axis compression” means the percentage of expansion or compression that should be applied to a coordinate in order to accurately place it on the sheet material, unless the context clearly dictates otherwise.

The use of “ink offset” means the difference between the actual ink placement and the location it is expected to be at, unless the context clearly dictates otherwise. A complete ink offset consists of an X,Y pair.

The use of “major axis” means the longer axis of a sheet of sheet material, unless the context clearly dictates otherwise. For example, if an 8.5×11 inch piece of sheet material is placed on the sheet material holder so that the long side of the sheet material will extend out from the material modifying device when the sheet material holder is in the material modifying device, the major axis will be the 11 inch long Y-axis.

The use of “minor axis” means the shorter axis of a sheet of sheet material, unless the context clearly dictates otherwise. For example, if an 8.5×11 inch piece of sheet material is place on the sheet material holder so that the long side of the paper will extend out from the material modifying device when the sheet material holder is in the material modifying device, the minor axis will be the 8.5 inch long X-axis.

The use of “origin point” means the 0,0 point of the piece of sheet material, typically the upper right hand corner of the paper, unless the context clearly indicates otherwise.

The use of “paper inset” means amount to move in from the corner of the sheet material, unless the context clearly indicates otherwise.

The use of “tool offset” means the distance between the sensor and the center point of the instrument, unless the context clearly indicates otherwise. A complete tool offset consists of an X,Y pair.

The use of “instrument” means a device for modifying material, including but not limited to writing instruments (e.g., pens, pencils, markers), cutting instruments, engraving instruments, and embossing instruments, unless the context clearly dictates otherwise.

The use of “modification instructions” means instructions, including user input, provided to a material modifying device for modifying material, unless the context clearly dictates otherwise.

The use of “user input” means information and command selections provided by a user, unless the context clearly dictates otherwise. Examples of user inputs include instructions received from an attached computer, instructions entered by a user via a user input (e.g., keyboard, buttons), instructions present on computer readable media (e.g., cartridges, memory sticks).

The use of “controller” means a programmable device that responds to a specific set of instructions, unless the context clearly dictates otherwise. Examples of controllers include programmable systems including systems and microcontrollers, reduced instruction set circuits (RISC), application specific integrated circuits (ASIC), programmable logic circuits (PLC), computers, computing devices, and any other circuit capable of executing the functions described herein, including but not limited to microprocessors, digital signal processors, analog processors, analog devices (e.g., switched capacitors), analog/digital logic circuits, discrete transistors, integrated circuits, and many other devices can be used to perform such processing.

The use of “sensor” means any device that performs at least one measurement of its environment and generates a signal regarding that measurement, including but not limited to, optical sensors, optical eyes (e.g., CCD or LED sensor/receiver combinations), proximity sensors, photoelectric sensors, and infrared sensors, unless the context clearly dictates otherwise.

The use of “position” means the orientation, location, angle of rotation, coordinates, scaling (whether the material or indicia on said material has been compressed or expanded), and/or direction in which material is positioned relative to a material holder, unless the context clearly dictates otherwise.

Disclosed herein are exemplary material modifying devices, and exemplary methods of using such material modifying devices. Some exemplary material modifying devices are computer controlled.

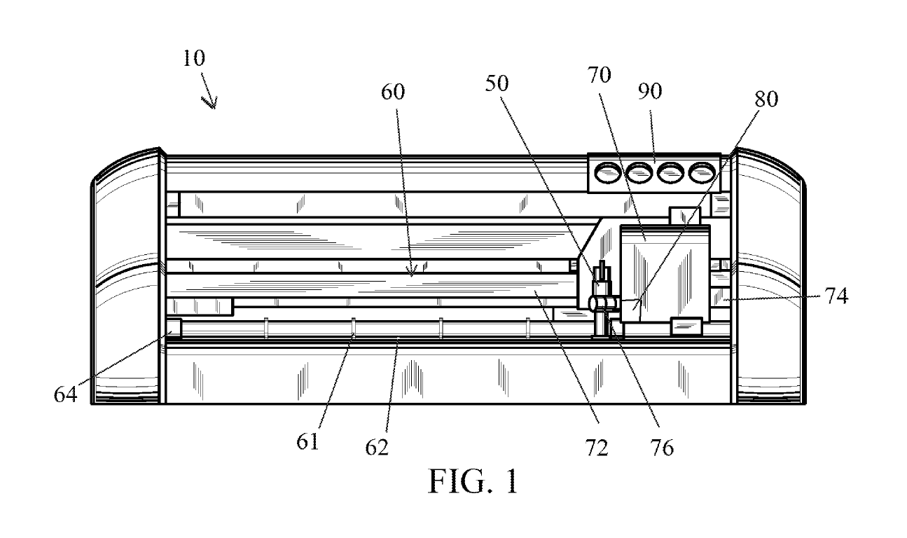

FIG. 1 illustrates an exemplary material modifying device 10 utilized with a sheet material holder 30. The sheet material holder 30 holding at least one piece of sheet material in place while modified by said material modifying device 10. This exemplary material modifying device 10 comprising a desktop personal electronic die cutter (cutting machine) utilized by scrapbookers, paper crafters and artists to cut sheet material, including but not limited to paper, scrapbook paper, cardstock, chipboard, balsa wood, vinyl, and pastry, among other sheet materials. Such a material modifying device 10 configured for connection to a personal computer. The personal computer is utilized (via user input) to send modification instructions to the material modifying device 10, and the material modifying device 10 follows those modification instructions to modify sheet material, for instance by cutting, embossing, engraving, piercing, distressing.

The material modifying device 10 is for use in modifying a sheet material held on a sheet material holder 30. The material modifying device 10 comprises a sheet material holder 30 for holding at least one piece of sheet material, at least one instrument 50 utilized to modify the sheet material, a carriage 70 for holding the instrument 50 and moving the instrument 50 relative to the sheet material in a first axis, a sheet handler assembly 60 for moving the sheet material perpendicular to the first axis, and at least one sensor 80. The material modifying device 10 includes a controller 90 which controls the operation of the material modifying device 10 based upon modification instructions defining how the instrument 50 should be used to modify the sheet material. The controller 90 receives such modification instructions and executes them.

The instrument 50 is utilized for modifying the sheet material. As such, exemplary instruments include, but are not limited to, pen tools, engraving tools, embossing tools, piercing tools and distressing tools. It is preferred that the instrument 50 is configured for being selectively moved between an engaged position wherein the instrument 50 is in contact with the sheet material, and a disengaged position wherein the instrument 50 is not in contact with the sheet material. For instance, the instrument 50 could be disposed liftably in the carriage 70 sot that the instrument can be raised and lowered. In such a configuration, the instrument 50 can be selectively engaged and disengaged, as required by particular modification instructions executed by the controller 90, to selectively modify certain portions of the sheet material while not modifying other portions of the sheet material.

The carriage 70 is configured for holding the instrument 50 in position to modify the sheet material. In the exemplary material modifying device 10 illustrated in these drawings, the material modifying device 10 comprises a rail 72 and at least one carriage motor 74 controlled by the controller 90. The carriage 70 is mounted on the rail 72. The carriage motor 74 is configured for reciprocatingly driving, based on modification instructions, the carriage 70 distally in an X-axis direction along the rail 72 crossing the sheet material on the sheet material holder 30, and driving the carriage 70 proximally in the X-axis direction along the rail 72. It is preferred that the X-axis direction be perpendicular to the Y-axis direction discussed with respect to the drive roller 61 and the pressure surface 62 infra. The carriage 70 preferably comprises a cradle 76 for holding the instrument 50.

The sheet material holder 30 has a surface 32 which is configured for receiving the sheet material thereon. Preferably, the sheet material holder 30 comprises an adhesive cutting mat wherein at least a portion of the surface 32 is coated with a releasable adhesive material configured for holding the sheet material in place while the instrument 50 modifies the sheet material. In some exemplary material modifying devices 10, the instrument 50 is configured for applying a force through the sheet material and against the sheet material holder 30. The sheet material holder 30 having a first end configured for inserting into the material modifying device 10 for handling by the sheet handler assembly 60.

It is preferred that the surface 32 of the sheet material holder 30 comprises a first color, and that the surface 3 of the sheet material comprise second (contrasting) color. Being contrasting, the sensor 80 can more easily determine the position of the sheet material on the sheet material holder 30 (as discussed infra). While a contrasting color is preferred, a skilled artisan will be able to select an appropriate color for the various components of an exemplary material modifying device in a particular embodiment based on various considerations, including the intended use of the material modifying device, the intended arena within which the material modifying device will be used, and the equipment and/or accessories with which the material modifying device is intended to be used, among other considerations.

The material modifying device 10 comprises at least one sensor. In the exemplary material modifying device 10 illustrated in these drawings, the sensor 80 is configured for sensing the position of the sheet material on the surface 32 of the sheet material holder. Upon sensing the position of the sheet material, the sensor 80 generates at least one position signal. The position signal is then transmitted to the controller 90. In sensing the position of the sheet material, the controller 90 can adjust the modification instructions to more precisely modify the sheet material. While the preferred sensor 80 is an optical detector, a skilled artisan will be able to select an appropriate sensor in a particular embodiment based on various considerations, including the intended use of the material modifying device, the intended arena within which the material modifying device will be used, and the equipment and/or accessories with which the material modifying device is intended to be used, among other considerations.

In operation, the controller 90 considers the information and data provided in the position signal relating to the position of the sheet material on the surface 32 when modifying the sheet material based on the modification instructions. This modification done by the controller 90 executing the modification instructions and moving the carriage 70 relative to the sheet material holder 30 and/or the sheet material holder 30 relative to the carriage 70 so that the instrument 50 modifies the sheet material according to the modification instructions.

For instance, the sensor 80 could sense the first edge of the sheet material, the second edge of the sheet material, and the first corner of the sheet material and the relationships of the first edge, second edge, and/or first corner to the X-axis direction of the rail 72 and generate the position signal. Based on this information (the position signal), the controller 90 could operate the instrument 50 to modify the sheet material according to the modification instructions. For instance, if the modification instructions provided for cutting a plurality of shapes from the sheet material, by factoring in the angle of the sheet material to the X-axis direction of the rail 72, a maximum number of said plurality of shapes could be cut into the sheet material. In further example, if the sheet material comprises an indicia 4 for which the instrument 50 is intended to modify (e.g., one or more borders to be cut out), by factoring in the angle of the sheet material to the X-axis direction of the rail 72, the border could be cut out accurately.

The sensor, in sensing the first edge of the sheet material, the second edge of the sheet material, and the first corner of the sheet material and the relationships of the first edge, second edge, and/or first corner to the X-axis direction of the rail 72, can effectively determine a 0,0 origin point (e.g., the upper right corner) for the material modifying device 10 to start from.

In one example, the modification instruction indicia are translatable into an alphanumeric code. The controller can then determine the modification instructions associated with the alphanumeric code, and execute the same. For instance, the modification instruction indicia could comprise a bar code for the number 000001. Upon the indicia sensor sensing the modification instruction indicia and generating a modification instruction indicia signal received by the controller, the controller could look up the modification instructions associated with that number in a table or database, and execute them. For instance, number 000001 could related to a star shape, and upon the controller determining that the modification instructions are for cutting a star shape in the sheet material, the controller could direct the material modifying device to perform such a cut.

The sheet material can comprise one or more pre-printed or otherwise defined indicia. For instance, the sheet material 2 could comprise indicia 4 comprising a shape, as illustrated in FIG. 4. In one exemplary use of the material modifying device 10, the modification of the sheet material is done relative to the indicia. For instance, the cutting instrument could cut the sheet material 2 along said indicia. In another example described infra, the sheet material 2 bears one or more calibration marks as the indicia 4.

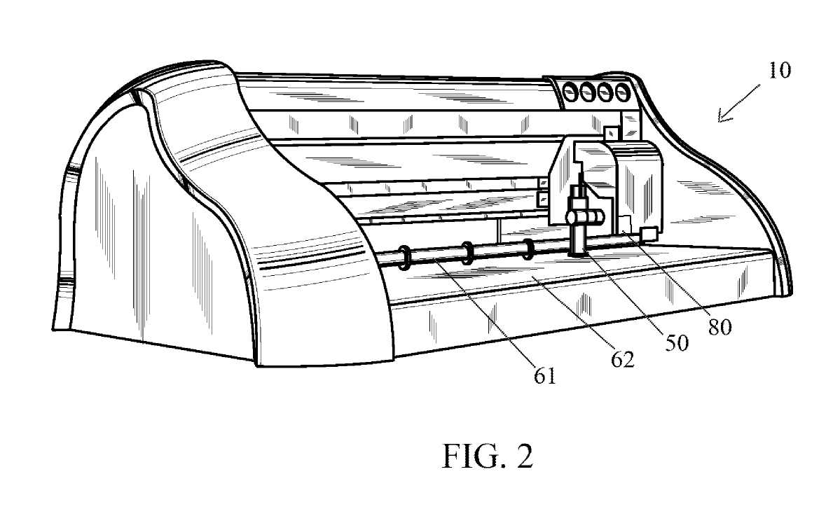

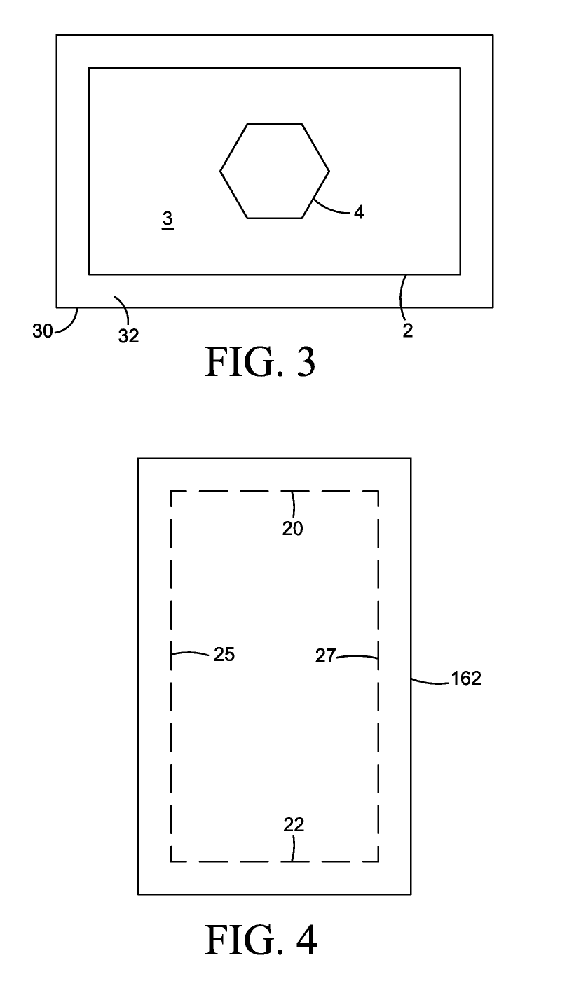

Referring back to FIGS. 1 through 3, the material modifying device 10 preferably further comprises sheet handler assembly 60 for moving the sheet material perpendicular to the first (X) axis. In the exemplary material modifying device 10 illustrated in these drawings, the sheet handler assembly 60 comprises a drive roller 61 and a pressure surface 62. Alternatively the pressure surface 62 could comprise a pressure roller. The drive roller 61 driven by at least one drive motor 64 controlled by the controller 90. The drive roller 61 and pressure surface 62 configured for receiving the sheet material holder 30 therebetween. In use the sheet material is held on the sheet material holder 30 sandwiched between the drive roller 61 and the pressure surface 62.

When so engaged, rotation of the drive roller 61 in a first rotational direction will draw the sheet material holder 30 through the material modifying device 10 in a first lateral direction (superiorly in a Y-axis direction). Contrarily, rotation of the drive roller 61 in an opposite, second rotational direction will draw the sheet material holder 30 through the material modifying device 10 in a second lateral direction opposite (inferiorly in the Y-axis direction) the first lateral direction. The drive roller 61 and the pressure surface 62 may be configured in a fixed relationship to one another, or may be able to be moved closer to one another or further apart from one another. It is preferred that the Y-axis direction be perpendicular to the X-axis direction discussed with respect to the carriage 70 supra.

In use, when the instrument 50 is in the engaged position, the sheet material holder 30 can be reciprocatingly moved along the Y-axis direction and/or the carriage 70 can be reciprocatingly moved along the X-axis direction to effectuate the modification of the sheet material.

The use of calibration marks (indicia) was mentioned supra. In order to ensure the most accurate matching of cutting operations to those printed on a standard printer, a calibration of the material modifying device may be performed, particularly when the user would like to adjust for improved accuracy, is using a significantly different medium, or switching to a different printer. Calibration consists of the following steps: printing of a calibration sheet on the printer to be used; initiating calibration mode on the material modifying device; user performed calibration steps; and completion of the calibration.

FIG. 4 illustrates the use of calibration marks. One example of the use of calibration marks printed on a calibration sheet is described herein. In this example, the sheet material (calibration sheet) 102 bears one or more calibration marks as the indicia. The sheet material 102 can be placed onto the sheet material holder 30, and the material modifying device 10 could be placed into a calibration mode whereby the sensor 80 senses the indicia (calibration marks) and generates a signal. The controller 90 then uses information in said signal to calibrate the material modifying device 10.

For example, the sheet material 102 could comprise an X-axis mark 20, and an X-axis compression mark 22. The sensor 80 could comprise an optical sensor. The sensor 80 could examine the sheet material 102 and determine the origin point (corner) of the sheet material 102, and the angle of the sheet material 102 on the sheet material holder 30 relative to one of the sides of the sheet material holder 30 or another reference line. Using the origin point and the angle of the sheet material 102, the sensor 80 could then search the sheet material 102 for the X-axis mark 20, and compare the actual location of the X-axis mark 20 to an expected location of the X-axis mark. The difference between the expected location and the actual location of the X-axis mark 20 could be set as the default X-axis ink offset.

The material modifying device 10 could add one or more registration marks on the sheet material 102 utilizing the instrument 50, and use the sensor 80 to compare the various marks to one another to determine if additional adjustments should be made to the X-axis ink offset to further adjust calibrate the material modifying device 10. Alternatively, the registration marks could be otherwise added to the sheet material. The registration mark can be used to adjust the ink offset for the modification to be made to the sheet material. The ink offset, read with the registration mark, can override the ink offset calculated during the calibration process. This allows the system to account for a printer which does not consistently print in the same location on a print out. The registration mark can be placed anywhere on the sheet material 102.

The instrument 50 could further mark the sheet material 102 at the expected X-axis mark location, and the user could be prompted to examine the two marks to determine if they line up. If they do not line up, the user could be prompted to provide feedback regarding how X-axis ink offset should be adjusted to align with the X-axis mark on the sheet material. After the X-axis ink offset is adjusted, the instrument 50 could again mark the sheet material at the expected X-axis mark location, and the user could be again prompted to determine if the marks are aligned. If not, further alignment adjustments could be performed.

Once the alignment is accepted, and the adjusted X-axis tool offset set, calibration could continue with the sensor 80 searching the sheet material 102 for an X-axis compression mark 22. Upon finding the X-axis compression mark 22, the controller 90 could, via the instrument 50, attempt to draw a line on top of the X-axis compression mark 22 on the sheet material 102. Upon completing the line, the user could be prompted to examine the two marks to determine if they line up. If they do not line up, the user could be prompted to provide feedback regarding how the drawn X-axis mark should be moved to align with the X-axis compression mark 22 on the sheet material. After the offset is adjusted, the instrument 50 could again mark the sheet material at the expected X-axis compression mark 22 location, and the user could be again prompted to determine if the marks are aligned. If not, further alignment adjustments could be performed.

Once the X-axis alignment is accepted, the sensor 80 could search the sheet material 102 for the X-axis compression mark 22 and compare the actual location of the X-axis compression mark 22 to the anticipated location of the X-axis compression mark. The difference between the anticipated location and the actual location of the X-axis mark could be used to calculate the X-compression or expansion of the instrument 50.

Additionally, using the origin point and the angle of the sheet material 102, the sensor 80 can then search the sheet material 102 for the Y-axis mark 25, and compare the actual location of the Y-axis mark 25 to an expected location of the Y-axis mark. The difference between the expected location and the actual location of the Y-axis mark 25 could be set as the default Y-axis ink offset. Then, the material modifying device 10 could mark one or more marks on the sheet material 102 utilizing the instrument 50, and use the sensor 80 to compare the various marks to one another to determine if additional adjustments should be made to the Y-axis ink offset to further adjust calibrate the material modifying device 10.

Then, the instrument 50 could mark the sheet material 102 at the expected Y-axis mark 25 location, and the user could be prompted to examine the two marks to determine if they line up. If they do not line up, the user could be prompted to provide feedback regarding how Y-axis ink offset should be adjusted to align with the Y-axis mark on the sheet material. After the Y-axis ink offset is adjusted, the instrument 50 could again mark the sheet material 102 at the expected Y-axis mark location, and the user could be again prompted to determine if the marks are aligned. If not, further alignment adjustments could be performed.

Once the alignment is accepted, and the adjusted Y-axis tool offset set, calibration could continue with the sensor 80 searching the sheet material 102 for a Y-axis compression mark 27. Upon finding the Y-axis compression mark 27, the controller 90 could, via the instrument 50, attempt to draw a line on top of the Y-axis compression mark 27 on the sheet material 102. Upon completing the line, the user could be prompted to examine the two marks to determine if they line up. If they do not line up, the user could be prompted to provide feedback regarding how the drawn Y-axis mark should be moved to align with the Y-axis compression mark 27 on the sheet material.

Once the Y-axis alignment is accepted, the controller 90 could, via the instrument 50, attempt to draw a line on top of the Y-axis mark on the sheet material 102. Upon completing the line, the user could be prompted to examine the two marks to determine if they line up. If they do not line up, the user could be prompted to provide feedback regarding how the drawn X-axis mark should be moved to align with the Y-axis mark on the sheet material 102. After the offset is adjusted, the instrument 50 could again mark the sheet material 102 at the expected Y-axis mark location, and the user could be again prompted to determine if the marks are aligned. If not, further alignment adjustments could be performed.

The aforementioned descriptions of the calibration of an exemplary material modifying device 10 is merely one example of steps that may be present in such a calibration. In use, one or more of the steps may be omitted, additional steps used, none of the steps used, and the like. A skilled artisan will be able to select an appropriate calibrations methods and steps for an exemplary material modifying device in a particular embodiment based on various considerations, including the intended use of the exemplary material modifying device, the intended arena within which the exemplary material modifying device will be used, and the equipment and/or accessories with which the exemplary material modifying device is intended to be used, among other considerations.

In use, an exemplary material modifying device could automatically load the sheet material to be modified to the 0,0 location when using a load/unload button or other user input on the device. The device could further comprise user input such as directional arrow keys for altering the 0,0 position.

In one exemplary process, the sheet material to be modified (physically altered, cut, drawn on, pierced, embossed, engraved) is placed on the mat. It is preferred that the color of the sheet material be of a high contrast to the mat (e.g., black mat for white material, white mat for black material). Next, the material modifying device 10 uses the optical eye to locate a corner of the sheet material, establishing an origin point. The material modifying device 10 then uses the optical eye to measure the rotation (angle) of the sheet material on the sheet material holder 30. This process can be referred to as “ink rotation calibration,” and one exemplary manner of performing ink rotation calibration is described infra. The material modifying device 10 can either send this information to the connected computer to allow the controlling software to compensate its output for these measurements, or the device can independently modify the output from the machine in order to properly operate on the sheet material.

One exemplary method of modifying a sheet material comprises the steps of: setting a 0,0 location; loading sheet material onto a sheet material holder 30; identifying a location of the sheet material on the sheet material holder 30; identifying a position of the sheet material on the sheet material holder 30; receiving modification instructions; and modifying the sheet material according to the modification instructions.

One exemplary method of using an optical sensor to locate a corner of the sheet material, thereby establishing an origin point, comprises the following steps. Move on the X-axis past the maximum start location of the paper origin. Scan along the Y-axis until the paper is found. Move back slightly from the paper edge. Move on the X-axis until the optical eye is past the paper origin minimum for the X-axis. Scan towards the paper origin maximum for X-axis. Determine if the sheet material was detected. If not, move slightly toward paper maximum Y, and repeat the steps above starting at “Move on the X-axis until the optical eye . . . ” If yes, save paper edge X sample. Then, determine if there been enough paper edge samples. If no, move slightly toward paper maximum Y, and move back from the paper edge slightly. If yes, eliminate outlier samples. Establish best fit path for remaining samples. Determine X origin using best fit path and Y location of first successful sample. Move on the Y-axis before the minimum start location of the paper origin Y. Move on the X-axis until slightly after the X origin of the paper. Scan towards the paper origin maximum for Y-axis. Determine if the paper detected. If not, move slightly toward paper maximum X and repeat the above steps starting at “Scan towards the paper origin maximum for Y-axis.” If yes, save paper edge Y sample. Determine if there been enough paper edge samples. If no, move slightly toward paper maximum X. If yes, move back from the paper edge slightly. Eliminate outlier samples. Establish best fit path for remaining samples. Finally, determine Y origin using best fit path and X location of first successful sample.

One exemplary method of using an optical sensor is an ink rotation calibration method that measures the rotation (angle) of the sheet material on a sheet material holder. The exemplary method comprises the following steps. Determine the longer side of the paper, either automatically or by using paper measurements passed in by the controlling computing device. The longer axis shall be referred to as the major axis and the smaller axis the minor axis. Move to the paper origin. Move back slightly from the edge of the paper along the minor axis to the minor axis scan start position. Move towards the major axis maximum slightly to the major axis paper inset position. Scan towards the paper in the minor axis until the paper is found. Save this coordinate. Move towards the major axis maximum until at the paper's major axis maximum—paper inset. Move in the minor axis direction away from the paper to the minor axis scan start position. Scan towards the paper in the minor axis until the paper is found. Save this coordinate. Calculate the angle of the paper using the coordinates found in these two scans. Alternative methods include performing multiple scans and creating a best fit path for the resulting coordinates, then determining the slope (angle) of the path.

One exemplary method of calibrating a material modifying device to a printer comprises the following steps: printing a calibration sheet on the printer, initiating a calibration mode on the material modifying device, examining the calibration sheet, and calibrating the material modifying device based on the calibration sheet.

Exemplary material modifying devices can be calibrated to nuances of other machine (e.g., offset, compression, rotation). Alternatively, the material modifying device can read one or more registration marks to make additional adjustments (e.g., offset, compression, rotation).

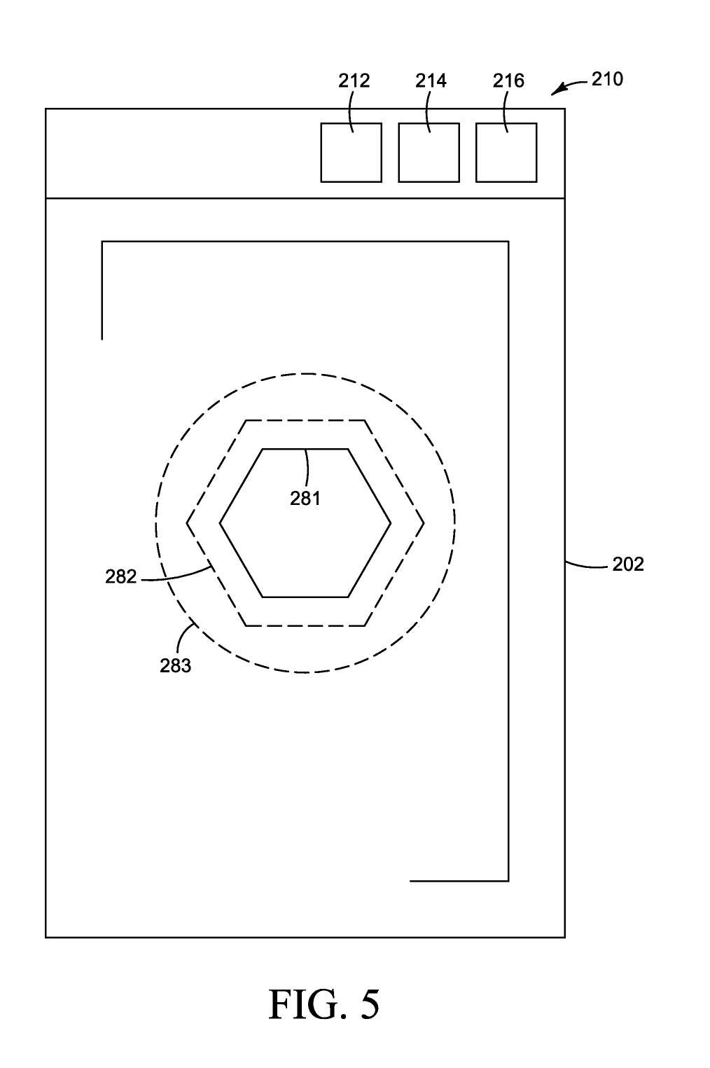

As illustrated in FIG. 5, an exemplary material modifying device can utilize coded instructions for specific operations to be performed on a sheet material 202. Digital instructions can be printed on the sheet material 202 with modification instruction indicia 210 for the processing to be performed, and the material modifying device can read these instructions and carrying them out with little or no intervention. In such a configuration, the material modifying device could be operated with no interaction with a connected personal computer at the time of the operation. The design (including the digital instructions) would be printed by any computer, or produced in mass by third parties. This design would consist of, at a minimum a registration mark and one data instruction code formatted in a machine readable format.

Optionally, as illustrated in FIG. 5, the material modifying device can further comprise an indicia sensor for sensing modification instruction indicia 210 marked or otherwise applied to the sheet material 202. The modification instruction indicia 210 comprising machine readable information, such as instructions for how the material is to be modified (e.g., cut, pierced, engraved). Examples of such machine readable information include, but are not limited to, QR Codes and bar codes.

FIG. 5 illustrates the use of three different modification instruction indicia 210, namely indicia 212, indicia 214, and indicia 216. The indicia sensor can sense the modification instruction indicia 210, and the controller can perform the operations specified in or by the modification instruction indicia 210. For instance, instructions provided in indicia 212 could be to cut along solid line 281, instructions provided in indicia 214 could be to draw a line along dashed line 282, and instructions provided in indicia 215 could be to pierce the sheet material 202 along dashed line 283.

When the sheet material is placed in the exemplary material modifying device, the sheet material is detected and machine readable instructions are read in using the optical eye. The actions specified in the machine readable instructions are carried out with limited to no involvement by the operator.

Any suitable structure and/or material can be used for the components of an exemplary material modifying device, and a skilled artisan will be able to select an appropriate structure and material for the components in a particular embodiment based on various considerations, including the intended use of the material modifying device, the intended arena within which the material modifying device will be used, and the equipment and/or accessories with which the material modifying device is intended to be used, among other considerations.

It is noted that all structure and features of the various described and illustrated embodiments can be combined in any suitable configuration for inclusion in a material modifying device according to a particular embodiment.

One example (Example A) of an exemplary material modifying device includes an instrument, a material holder, a controller, and a sensor. The material holder is configured to support a sheet material to be modified. The sheet material holder can be moved relative to the instrument so that the sheet material can be properly modified. By “moved relative to” it is meant that that the instrument can be moved relative to the sheet material and/or the sheet material can be moved relative to the instrument. The controller controls the operation of the material modifying device, receiving modification instructions from user input, and receiving a signal from the sensor. The sensor senses the position of the material on the sheet material holder, and to generate a position signal. The signal is relayed to the controller. The controller controls the movement of the sheet material holder relative to the instrument, consistent with the modification instructions and considering the position signal, which results in modification of the material. Optionally, registration marks on the sheet material could be used by the sensor to determine position.

Another example (Example B) of an exemplary material modifying device comprises all features mentioned in “Example A” and further includes the material holder having a contrasting (to the sheet material) surface color. Whereas the Example A did not specify colors of the sheet material holder and sheet material, Example B specifies that the colors are contrasting. This allows for the position of the material to be more-easily detected by the sensor.

Another example (Example C) of an exemplary material modifying device comprises all features mentioned in “Example A” and also includes an attached computer for user-defined input. Whereas Example A did not specify how the controller received modification instructions, Example C interfaces with a computer, and the computer provides instructions to the device (via the controller) regarding how to modify the sheet material.

Another example (Example D) of an exemplary material modifying device comprises all the features mentioned in “Example A” and further includes the sheet material having indicia thereon, and a sensor for sensing the indicia. The sensor could be same as the Example A sensor, or a second sensor. The sensor can be an optical detector. The indicia can contain instructions for the modification of the sheet material. The sensor “reading” the indicia and generating an instruction signal. The instruction signal relayed to the controller. Based on the information in the instruction signal, the controller controls the movement of the sheet material holder relative to the instrument, which results in the modification of the material.

The foregoing detailed description provides exemplary embodiments of the invention and includes the best mode for practicing the invention. The description and illustration of these embodiments is intended only to provide examples of the invention, and not to limit the scope of the invention, or its protection, in any manner.

What is claimed is:

1. A material modifying device for use in modifying a sheet material, said material modifying device comprising:
an instrument for modifying said sheet material;
a carriage, said carriage configured for holding said instrument in position to modify said sheet material;
a sheet material holder having a surface, said sheet material holder configured for holding said sheet material on said surface;
a controller for receiving modification instructions for how said instrument is to modify said sheet material; and
at least one sensor configured for sensing the position of the sheet material on said surface, said sensor generating at least one position signal, said position signal received by said controller,
wherein considering said position signal, said controller executes said modification instructions and moves said carriage relative to said sheet material holder and said sheet material holder relative to said carriage so that said instrument modifies said sheet material according to said modification instructions.

2. The material modifying device of claim 1, wherein said surface comprises a first color, and wherein said sheet material comprises second color, wherein said first color and said second color are contrasting colors.

3. The material modifying device of claim 1, wherein said sheet material holder comprises an adhesive cutting mat.

4. The material modifying device of claim 1, wherein said instrument comprise a cutting instrument.

5. The material modifying device of claim 1, wherein said sensor is an optical detector for detecting the position of said sheet material on said sheet material holder.

6. The material modifying device of claim 1, wherein said sheet material comprises indicia marked thereon.

7. The material modifying device of claim 6, wherein the modification of the material is done relative to the indicia.

8. The material modifying device of claim 1, further comprising a drive roller and a pressure surface, wherein said drive roller is driven by at least one drive motor.

9. The material modifying device of claim 8, wherein said sheet material holder is configured for receipt between said drive roller and said pressure surface, and wherein said drive roller driven by said drive motor is configured for selectively driving said sheet material holder superiorly in a Y-axis direction and inferiorly in said Y-axis direction.

10. The material modifying device of claim 9, wherein said material modifying device comprises a rail and at least one carriage motor, wherein said carriage motor is configured for reciprocatingly driving said carriage distally in a X-axis direction along said rail, and proximally in a X-axis direction along said rail, wherein said X-axis direction is perpendicular to said Y-axis direction.

11. The material modifying device of claim 10, wherein said instrument can be moved into an engaged position wherein said instrument is in contact with said sheet material, and wherein said instrument can be moved into a disengaged position wherein said instrument is not in contact with said sheet material.

12. The material modifying device of claim 11, wherein when said instrument is in said engaged position, said sheet material holder can be reciprocatingly moved along said Y-axis direction and said carriage can be reciprocatingly moved along said X-axis direction to effectuate the modification of said sheet material.

13. The material modifying device of claim 1, wherein said material modifying device comprises a rail and a carriage motor, wherein said carriage motor is configured for reciprocatingly driving said carriage in a distal direction along said rail, and in a proximal direction along said rail.

14. The material modifying device of claim 1, wherein said material modifying device comprises a rail and at least one carriage motor, wherein said carriage motor is configured for reciprocatingly driving said carriage distally in a X-axis direction along said rail, and proximally in a X-axis direction along said rail.

15. The material modifying device of claim 1, further comprising an indicia sensor for sensing indicia marked upon said sheet material, and wherein said indicia comprise said modification instructions.

16. The material modifying device of claim 1, further comprising a drive roller and a pressure surface,
wherein said drive roller is driven by at least one drive motor,
wherein said sheet material holder is configured for receipt between said drive roller and said pressure surface,
wherein said drive roller driven by said drive motor is configured for selectively driving said sheet material holder superiorly in a Y-axis direction and inferiorly in said Y-axis direction,
wherein said material modifying device comprises a rail and at least one carriage motor,
wherein said carriage motor is configured for reciprocatingly driving said carriage distally in a X-axis direction along said rail, and proximally in a X-axis direction along said rail,
wherein said X-axis direction is perpendicular to said Y-axis direction,
wherein said instrument can be moved into an engaged position wherein said instrument is in contact with said sheet material,
wherein said instrument can be moved into a disengaged position wherein said instrument is not in contact with said sheet material, and
wherein when said instrument is in said engaged position, said sheet material holder can be reciprocatingly moved along said Y-axis direction and said carriage can be reciprocatingly moved along said X-axis direction to effectuate the modification of said sheet material.

17. The material modifying device of claim 16, further comprising an indicia sensor for sensing indicia marked upon said sheet material, and wherein said indicia comprise said modification instructions.

18. The material modifying device of claim 16, wherein said sheet material holder comprises an adhesive cutting mat, and wherein said instrument comprises a cutting instrument.

19. A material modifying device for use in cutting a sheet material, said material modifying device comprising:
a cutting instrument for cutting said sheet material;
a carriage, said carriage configured for holding said instrument in position to cut said sheet material;
a rail and at least one carriage motor;
a drive roller and a pressure surface, wherein said drive roller is driven by at least one drive motor;
a sheet material holder having a surface, said sheet material holder configured for holding said sheet material on said surface, said sheet material holder comprising an adhesive backed cutting mat;
a controller for receiving modification instructions for how said instrument is to cut said sheet material; and
at least one sensor configured for sensing the position of the sheet material on said surface, said sensor generating at least one position signal, said position signal received by said controller, wherein said sensor is an optical detector,
wherein considering said position signal, said controller executes said modification instructions and moves said carriage relative to said sheet material holder and said sheet material holder relative to said carriage so that said instrument cuts said sheet material according to said instructions,
wherein said sheet material holder is configured for receipt between said drive roller and said pressure surface, and wherein said drive roller driven by said drive motor is configured for selectively driving said sheet material holder superiorly in a Y-axis direction and inferiorly in said Y-axis direction,
wherein said carriage motor is configured for reciprocatingly driving said carriage distally in a X-axis direction along said rail, and proximally in a X-axis direction along said rail, wherein said X-axis direction is perpendicular to said Y-axis direction,
wherein said instrument can be moved into an engaged position wherein said instrument is in contact with said sheet material, and wherein said instrument can be moved into a disengaged position wherein said instrument is not in contact with said sheet material,
wherein when said instrument is in said engaged position, said sheet material holder can be reciprocatingly moved along said Y-axis direction and said carriage can be reciprocatingly moved along said X-axis direction to effectuate the cutting of said sheet material, and
wherein said material modifying device comprises a rail and a carriage motor, wherein said carriage motor is configured for reciprocatingly driving said carriage in a distal direction along said rail, and in a proximal direction along said rail.

20. A method of modifying a sheet material comprising:
setting a 0,0 location;
loading material onto a sheet material holder;
identifying a location of the sheet material on the sheet material holder;
identifying a position of the sheet material on the sheet material holder;
receiving modification instructions; and
modifying the sheet material according to said modification instructions.
